(19) United States
(12) Patent Application Publication
(10) Pub. No.: US 2010/0042502 A1
(43) Pub. Date: Feb. 18, 2010

(54) SYSTEM AND METHOD FOR CREATING, PROMOTING AND TRACKING VOUCHERS WITHIN A COMMUNITY

(76) Inventors: Fati Farmanfarmaian, San Francisco, CA (US); Cliff W. Elgin, Palo Alto, CA (US); Joseph Noon, JR., Danville, CA (US)

Correspondence Address: HAYES SOLOWAY P.C., 3450 E. SUNRISE DRIVE, SUITE 140, TUCSON, AZ, 85718, US

(21) Appl. No.: 12/435,310

(22) Filed: May 4, 2009

Related U.S. Application Data
(63) Continuation-in-part of application No. 12/192,799, filed on Aug. 15, 2008.

(51) Int. Cl. G06Q 30/00

(52) U.S. Cl. 705/14.58

(57) ABSTRACT

The system includes a communication source formed with a computer-accessible network having a software platform that supports a sale of a plurality of vouchers. A voucher creation system is in communication with the communication source. The voucher creation system allows at least one entity to create at least a first voucher of the plurality of vouchers for sale through the software platform by identifying terms of the first voucher. At least one potential buyer has sufficient access through the software platform to purchase the first voucher.

### CROSS REFERENCE TO RELATED APPLICATIONS

The present application is a continuation-in-part (CIP) of U.S. application Ser. No. 12/192,799, filed Aug. 15, 2008, the contents of which are incorporated herein by reference.

### FIELD OF THE INVENTION

The present invention is generally related to online business promotion, and more particularly, is related to a system and method for providing promotional opportunities within a community. The invention has particular utility in connection with online promotion of for profit business entities and will be described in connection with such utilities, although other utilities are contemplated, including promotion of charitable organizations as well as service and/or goods swapping.

### BACKGROUND OF THE INVENTION

Since the early 1990s, the Internet has been changing the dynamics of commerce. Online purchasing by buyers has been steadily increasing for well over a decade. Various other online activities has also been increasing for years. This activity has resulted in the development of significant and varied online communities. Developments such as blogs, MYSPACE pages, 2^{nd} LIFE, and others, have helped to generate online societies and individuals with vast followings and little opportunity for generating revenues from their positions. On the other hand most businesses cannot access online clients as they are reliant on in-store commerce, vs. commerce through a Web site. Furthermore, many businesses do not have a Web site. This is particularly true for service-sector businesses and local businesses that cannot sell hard goods or services across the Internet.

Also, there has been massive fraud in the coupon arena, as national brands provide discount coupons against their goods (e.g., Brand X toothpaste). There are many forms of coupon fraud—. This describes a couple of common variants. These coupons—get redeemed in third party retail locations that do not belong to the national brand (e.g., Brand X). Fraud takes place in the following way: the retailer collects 10 coupons—, with which Brand X offers customers “2 tubes, third is free”. Brand X pays back the retailer for the tube the retailer gives away with each redemption. But the retailer instead of giving away a Brand X tube, is instead giving away a case of cheaper Brand Y. In another version of the fraud, the retailer gets an associate to come in with 10 coupons—for which he gets 30 tubes of toothpaste (10 of which are free), which he then sells at a tidy profit across town. In both cases, Brand X ends paying as it cannot verify the transaction. The present invention solves these problem by leveraging a voucher based model, rather than the traditional coupon model.

Additionally, it can be difficult to buy gift certificates online for redemption at local, physical locations, as most local stores do not present the opportunity and many others do not have a web site. Current technology for remote gift card purchase involves calling the store, paying via credit card and giving the name of the beneficiary. The store then might mail the gift certificate to the beneficiary.

Thus, a heretofore unaddressed need exists in the industry to address the aforementioned deficiencies and inadequacies.

### SUMMARY OF THE INVENTION

Embodiments of the present invention provide a system and method for providing promotional opportunities.

Briefly described, in architecture, one embodiment of the system, among others, can be implemented as follows. The system includes a communication source formed with a computer-accessible network having a software platform that supports a sale of a plurality of vouchers. A voucher creation system is in communication with the communication source. The voucher creation system allows at least one entity to create at least a first voucher of the plurality of vouchers for sale through the software platform by identifying terms of the first voucher. At least one potential buyer has sufficient access through the software platform to purchase the first voucher.

The present invention can also be viewed as providing methods for providing promotional opportunities within a community. In this regard, one embodiment of such a method, among others, can be broadly summarized by the following steps: forming a communication source within a computer-accessible network having a software platform that supports a sale of a plurality of vouchers; allowing at least one entity to create at least a first voucher of the plurality of vouchers for sale through the software platform by identifying terms of the first voucher; and providing access for a potential buyer for purchasing the first voucher.

Yet another aspect of the present invention provides a method for rewarding users based upon the performance of businesses the user recommended. The performance for each business may be measured against other businesses and placed in a ranking according to one of a plurality of business categories.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of a system for providing promotional opportunities within a community, in accordance with a first exemplary embodiment of the invention; and

FIG. 2 is a flowchart illustrating a method of providing promotional opportunities within a community utilizing the system shown in FIG. 1, in accordance with the first exemplary embodiment of the invention.

### DETAILED DESCRIPTION

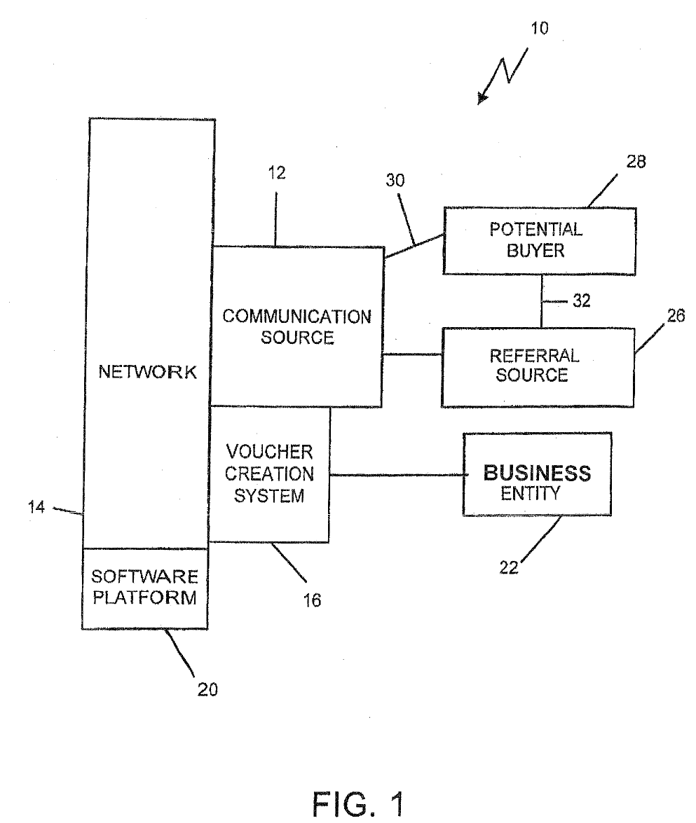

FIG. 1 is a block diagram of a system 10 for providing promotional opportunities, in accordance with a first exemplary embodiment of the invention. The system 10 includes a communication source 12 formed with a computer-accessible network 14 having a software platform 20 that supports a sale of a plurality of vouchers. A voucher creation system 16 is in communication with the communication source 12. The voucher creation system 16 allows at least one entity 22 to submit the terms for the creation of at least a first voucher of the plurality of vouchers for sale by the software platform 20 by identifying terms of the first voucher. At least one potential buyer 28 has sufficient access through the software platform 20 to purchase the first voucher.

The present invention provides a system 10 for providing promotional opportunities that are particularly useful to local businesses reliant on physical interactions with customers. The present invention may enable local businesses to post offers online that buyers buy online, typically but not necessarily at a discount, and come to the physical store to collect. The present invention may also enables small businesses, who might not have a web site, to sell gift certificates to online customers.

While the system 10 is herein described as having one entity, typically a business entity 22, one referral source or negotiator 26 (note these can be two different entities: the entity that negotiated or sourced the offer with the business, and the entity that referred the buyer), and one potential buyer 28; the vision for the exploitation of the system 10 is to have a multitude of entities 22, referral sources or negotiators 26, and potential buyers 28. Under the system 10, a referral source or negotiator 26 is one who has the ability to connect entities 22 and the vouchers thereof to buyers 28 can utilize the present system 10 to bring voucher sales to the entity 22. When two or more entities are involved, they may split the referral fee.

A referral source 26, having sufficient access through the software platform 20 to promote the vouchers related to goods and services of the entity 22 to potential buyers 28, may also be an entity 22 or potential buyer 28 in this and other deals. The system 10 may also include a buying channel 30 between the buyer 28 and the entity 22 through the referral source 26, whereby the buyer 28 has sufficient access through the software platform 20 of the communication source 12 to purchase the vouchers through the referral source 26. One possible alternative to this arrangement would be to have the referral source 26 simply lead the buyer 28 to a site operated by the entity 22 or the communications source 12 to complete a voucher sale, with a source identification of the sale in place to allow the referral source 26 to get credit for the referral.

In this arrangement, the business entity 22 and the software platform 20 can be neither, one or both offer negotiator and referral source of buyers (treated as one entity 26).

The system 10 may include the referral source 26 having a second channel 32 of communication to solicit the buyer 28. The concept and/or performance of the role of the referral source 26 includes various ideas, including bloggers, emails, informational web sites, and personal web pages (such as MYSPACE™ pages). The referral source 26 may also utilize web pages supported by the communication source 12 to reach the potential buyers 28. Other opportunities for referral source 26, both from within and from outside the system 10 may be realized by those having ordinary skill in the art and all such opportunities for promotion are considered to be within the scope of the present invention.

The system 10 may also include the software platform 20 of the communication source 12 having the capacity to allow the entity 22 to accept voucher terms related to entity 22's goods or services as submitted by referral source 26 or company operating software platform 20, thereby becoming an accepted offer. The system 10 may further include the software platform 20 of the communication source 12 having the capacity to oversee performance of the accepted offer. A purpose of the system 10 may be to enable referral sources 26 to reach out to buyers 28 and promote the vouchers related to goods and services of the entities 22. In this regard, it may be useful for the software platform 20 of the communication source 12 to track performance of a referral source 26. Further, when an accepted offer includes a payment to the referral source 26, upon sale of one of the vouchers, the system 10 may automatically process the payment generated from sales of goods and services of entity 22 to the referral source 26.

In one embodiment, the process may operate as follows. “Face Value” (F) shall mean the dollar amount the voucher may purchase in goods and at services at the issuing entity 22. “Wholesale Value” (W) shall mean the price at which entity 22 agrees to sell goods or services to a company operating the software platform 20. “Buyer Price” (B) shall mean the price at which company operating the software platform 20 sells vouchers with rights to related goods or services, to buyers 28. “Total Units” (Tu) shall mean number of vouchers to be sold by the company operating the software platform 20.

At T0, software platform 20 publicizes goods and services submitted by entities 22, as offers, discounts and tickets (other names can be used). At T1 when a buyer 28 appears, the software platform 20 buys the first good or service from entity 22 at W and sells a voucher (with code) to buyer 28 at B, enabling buyer to collect the good or service at the location of entity 22, leaving Tu−1 in inventory. The difference between B and W, net of the Fees (B-W-Fees) is left for bounties to the company operating the software platform 20 and the referral source 26. If the software platform 20 cannot sell the voucher, it may split B with other referral sources 26. Additionally, the software platform 20 may reduce or increase B, or change the terms of the voucher agreement as long as W and Tu remain unchanged, without the consent of business entity 22. The software platform 20 has sold out the Voucher Agreement when Tu=0. Another variant involves the software platform contracting to buy the first good or service at W, after it has received payment B. This process is repeated as above until Tu=0.

The buyer's credit card can be billed either at time of voucher code issuance to buyer, or very close to the time when the voucher code is redeemed by the retail store 22. In another variant, upon the issuance of the voucher code to the buyer 28, the retail store “reserves” the item for a limited time for buyer 28 to inspect, prior to final voucher redemption and payment disbursement.

When buyers buy a voucher, they are given a numerical or digital code, which they present at the retail store to claim their goods and services. The business verifies the codes by dialing a toll free number, or via a Web interface or via an automated technology such as a digital scanner.

The codes can be created using the following methodology:
a. The buyer 28 is issued a complete code (for example, consisting of 8 digits and 2 letters).
b. Simultaneously, the business is issued an incomplete code (for example, consisting only of the first 8 digits).
c. The business 22 can print up its list of incomplete codes and keep them at the door of its venue.
d. Buyer 28 delivers the complete 10 unit code (8 digits, 2 letters) enabling business 22 to look up the 8 digit code and add the 2 letters to form the complete code.
e. At a later moment, the business 22 can efficiently redeem all of its codes in one session.
f. The incomplete code methodology can be made more secure by adding personal identity markers into the code. For example, in the case above, last 4 digits of the 8 digit code can be the last 4 digits of the buyer 28's credit card number. The business 22 can then request to see the credit card to securely associate the individual with the code. For example, in the launch iteration, the buyer code consists of 8 digits, plus the last 4 digits of their credit card. The business 22, will only be given the first 8 digits and will have to ask for the 4 credit card digits to redeem the code.
g. Identity markers can include and are not limited to digits on credit cards, social security numbers or driving licenses.
h. Another element of security can include the requirement that the buyer 28 sign next to the business 22's complete code.

Meanwhile, Fees are calculated as x % of Buyer Price. X % is set by the software platform. So the difference between B and W can be expressed as:

B−W=(x%*B)+Bo,

where Bo is the bounty, set by the business to reward users for promoting the voucher/offer. Therefore the bounty can be expressed as:

Bo=B−W−(x%*B).

The complete equation that calculates the entire pricing mechanism and software platform Fees (x %*B) is expressed as such:

(x%*B)=F−BD−W−Bo, where BD is the Buyer Discount (the difference between F and B, or F−B).

Note, the model is flexible. Fees calculated as x %*B, can be taken out of the current pricing formula to be instead billed separately to buyers or businesses, possibly resulting in a larger bounty Bo or a more attractive Buyer Price.

The software platform aims to display the most appropriate vouchers or offers to the most likely buyers. The following formulas may be utilized to determine voucher display, wherein VP is Voucher Profitability; C is number of conversions (sales); I is number of impressions; B is the bounty shared between the operator of the software platform 20 and the offer source and referral sources 26; PR is participation rate; and D is discount to the buyer 28.

Voucher offers can be displayed to potential buyers 28 using the following formula, where VP is an indicator of Profitability. The vouchers may get displayed in order of most profitable first:

VP=(C/I)*B+D;

(C/I)=PR; and thus

VP=PR*B+D.

Vouchers can also be displayed via the following variants:

Buyer Profitability=PR*D

Referral source Profitability=PR*B

VP/customer cost=PR*(B+D)/total customer expenditure on Voucher

Buyer Profitability/customer cost=PR*D/total customer expenditure on Voucher

Referral source Profitability/customer cost=PR*B/total customer expenditure on Voucher

Or the voucher may be displayed using any of the above variants with the Participation Rate (PR) set at approximately 1. Because at the beginning of campaigns Participation Rate may be hard to calculate, setting PR to approximately 1 may be a reasonable initial approximation. In another variation, B may be broken into its constituent parts, namely; software platform 20 operator bounty (N) and referral source bounty (P), where N+P=B. All the equations above can be optimized to weight in favor N or P as the determinant of B.

If the initial referrer 26 finds that it is having difficulty selling its vouchers, it might decide to split its bounty (Bo) by a percentage set by initial referrer 26 or by software platform 20, with other referrers.
This modifies the bounty formula from:

Bo=B−W−(x%*B)

To:

(B1+B2)=B−W−(x%*B), where B1 is the Bounty of the initial referrer and B2 is the bounty allocation shared with other referrers (Bo=(B1+B2))

Vouchers priced using this formula can be displayed with a higher priority based on the size or percentage of B2 in reference to B.

These arrangements also allow referrers/negotiators 26 to offer to move a certain number of goods/services from business 22 at a pre-arranged Wholesale price (W) and Quantity Tu, thereby taking the place of the software platform 20 in negotiating and referring buyers. The referrer/negotiator would be committed to buying and reselling the inventory. If referrer/negotiator can not sell its inventory it can split its bounty fee Bo or, it could ask the software platform 20 to help it clear its inventory. This agreement is subject to software platform's approval, as software platform acts referrer/negotiators' market maker, contracting with business 22 to buy at W. The software platform disburses the appropriate referral fees to the referrer(s).

Once the contract is in place, referrer 26 has authority to sell the agreed upon Tu goods and services at price W, as best s/he can. For example, referrer can increase or decrease Buyer Price (B), which in turn will increase or decrease referrer 26's Bounty (Bo). If business 22 agrees with referrer/negotiator 26 such an agreement can be created and changed via software platform.

A variant may be enabled that verifies voucher and coupon redemptions with products sold, to a high level of certainty. This methodology works with brands and companies that use bar code data. When an item is scanned via bar code, the following data is captured and sent to the national brand or manufacturer: store location (L), time of transaction (T), unit sold (U) and its associated manufacturer suggested retail price or MSRP (P). Upon the redemption of a voucher, the software platform 20 captures the following data: store location (l), time of transaction (t) and voucher redeemed with the store price (p) of the good involved (u). By making the voucher redemption data available to national brand name companies, these companies can use this data to match redemption data with their barcode data, providing an almost certain (but not 100% certain) methodology to track and verify that goods have been sold in conjunction with voucher redemptions. In other words, a national brand name company will know if a voucher redeemed generated the movement of an associated product if:

L=l, U=u, T=t (T may have an error range of + or − x minutes; x could be 3 minutes) and P=p (P may have a range of acceptable pricing, depending on the specific offer and retailer mark-ups. For example, some offers may require buyers 28 to spend more or less than the voucher amount). Importantly, the national brand will also know that the item moved was associated with an independent customer generated through the software platform 20, as opposed to other vouchers or coupons. Though the software platform 20 may not share specific buyer 28 information with the national brand name company, it may verify that the vouchers/coupons were associated with an appropriately distributed user base.

When the entity 22 enters the voucher information into the voucher creation system 16, the entity 22 may identify, the number of vouchers available for sale, the face value of the voucher, the sale price of the voucher, a referral fee for the referral source 26 (paid out only if a referral source 26 is utilized) and restrictions on the voucher (days, hours, or seasons the voucher may be redeemed, locations where it may be redeemed, etc.). Buyers 28 and referral sources 26 may sort vouchers to consider for purchase/referral based on the voucher characteristics entered by the entity 22. A referral source 26, such as a newspaper or blogger, may only want to advertise vouchers that may be redeemed locally. Buyers 28 may only want to see vouchers on certain products, certain percentage discounts, for online redemption, etc.

Newspapers may publish vouchers provided by the software platform. To buy vouchers, Buyers would go to a private label version of the software platform, created for the newspaper. The newspaper would therefore earn referral fees.

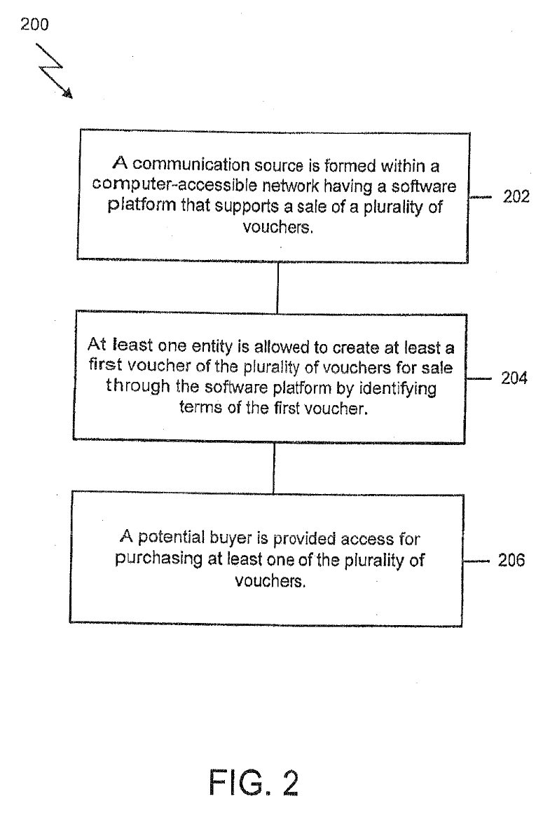

FIG. 2 is a flowchart 200 illustrating a method of providing promotional opportunities within a community utilizing the system 10 shown in FIG. 1, in accordance with the first exemplary embodiment of the invention. It should be noted that any process descriptions or blocks in flow charts should be understood as representing modules, segments, portions of code, or steps that include one or more instructions for implementing specific logical functions in the process, and alternate implementations are included within the scope of the present invention in which functions may be executed out of order from that shown or discussed, including substantially concurrently or in reverse order, depending on the functionality involved, as would be understood by those reasonably skilled in the art of the present invention.

As is shown by block 202, a communication source is formed within a computer-accessible network having a software platform that supports a sale of a plurality of vouchers. At least one entity is allowed to create at least a first voucher of the plurality of vouchers for sale through the software platform by identifying terms of the first voucher (block 204). A potential buyer is provided access for purchasing at least one of the plurality of vouchers. (block 206).

The method may further include the step of establishing a buying channel through the software platform 20 of the communication source 12, which allows the buyer 28 to purchase at least one of the plurality of vouchers of the entity 22 through the referral source 26.

The method may also include establishing a promotional channel of communication through the software platform 20 of the communication source 12. Establishing the promotional channel of communication provides a pathway for the referral source 26 to solicit the buyer 28.

The method may also include monitoring performance of the sale of vouchers. The method may further include tracking voucher sale, wherein the accepted offer includes a payment to the referral source(s) 26 upon sale of one or more of the vouchers. The system 10 may automatically process the payment to the referral source(s) 26 upon sale of the vouchers. The method may monitor the performance of the promotion in relation to geographic areas.

The present invention also allows local businesses without a web site to sell gift certificates online. Once the business (Bb) agrees to the terms of the software platform service, the software platform displays (Bb) on the software platform's site (S). A buyer can come to S, select Bb and enter a dollar gift amount (A), to be credited to a beneficiary, whose email address is entered by the buyer. The buyer gets billed a service fee, and A (minus fees) is wired or sent as a check to the Bb, for credit in the name of beneficiary. Beneficiary receives an email notification that s/he has received a gift certificate to the amount of A, that s/he should pick up at his/her convenience. To redeem the gift certificate, the beneficiary merely displays a numerical or digital code to Bb. Bb verifies the code by dialing a toll free phone number or via a Web interface, or via an automated technology such as a digital scanner.

The invention also procures to display gift certificates via the following methodologies. A business (Bb) can set a bounty. The higher the bounty the higher Bb's listing will be placed. A variation involves the following: the Bounty (Bo) can never be greater than a x % of total Buyer Spend (Bsp). So business Bb sets Bo and the x % limit, so that:

Bo=<(x%*Bsp)

Another way of displaying the gift certificates involves the creation of “Display Rank” (DR) where DR is established by:

DR=Bo/GCE,

where GCE is the historical buyer expenditure per gift certificate, for that business, or that business category. Where there is a lack of historical record, GCE may be substituted by a constant.

As should be clear from the foregoing, an advantage of the present invention over the prior art is that the cost of the promotion will have a direct relation, or a substantially direct relation, to the amount of sales resulting from the promotion.

In another aspect of the present invention, the system disclosed herein is enhanced by a method for rewarding individuals for identifying businesses. In general, this method allows users to rank businesses in a particular category by preference. For example, businesses for users A, B, and C in the category of restaurants R (where the term ‘category’ is defined as any set using definitional elements selected by an observer, including geographical elements) are ranked in the top-to-bottom order as follows (where each business is named by a lower case letter a, b, c, or d):
For user A in category R: a=1, b=2, c=3, d=4 . . .
For user B in category R: a=1, b=4, c=2, d=3 . . . .
For user C in category R: a=3, b=1, c=4, d=2 . . .
   The ranking is for each business is then calculated by averaging its position across category R for each of users A, B, and C:

A(R): (1−1+2)/3=1.33

B(R): (2+3+1)/3=2.00

C(R): (3+2+4)/3=3.33

D(R): (4+3+2)/3=3.33

The user who was the first to add the business with the highest average ranking of the category, gets a reward or non-monetary recognition. In this case, if B was the first to add business A to the set, B receives reward or recognition. The recognition moves to another user, when business A is displaced from the top spot. This enables the community to recognize and reward individuals who are provide value to the community by identifying new businesses, This ranking and reward methodology can be taken across a large set up users, businesses and categories.

The present invention further provides another method for ranking businesses using historical purchase history. According to this method, the purchase history of a particular user in a given category is ranked by how many times the user has patronized each business (defined as spent funds at a specific time t1, or subsequent times). For example, if business (a) was patronized on 3 times (at t1, t2 and t3), the business gets a rating of 3. This enables the business to be ranked by rating against other businesses in its category.

For example, for category R, A may have purchased 3 times at a, 1 time at b and times at c and 2 times at d, giving each business a purchase ranking for A of:
business (a): 3
business (b): 1
business (c): 4
business (d): 2
   where 4 is the highest ranking. To get average purchase rankings across user groups these purchase rankings can be averaged across user groups using a similar methodology as above. These purchase ranking may further be enhanced by weighting the rankings according to the amount spent with each purchase.
   Searching friends' likes works as follows:
   1. Search from my home page will include results from me+my friends;
   2. Search from B's profile page will include results from B+B's friends;
   3. All results in either scenario should include my likes, when a result is one of my likes, so:

(a) I like Panda Express, I search B's friends in Danville, none of them like it, it isn't returned as a result, so me liking it has no impact; or

(b) I like Costco, I search B's friends in Danville, 2 of them like it, I see their marks+comment, and mine in Costco

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A system for providing promotional opportunities, the system comprising:
a communication source formed with a computer-accessible network having a software platform that supports a sale of a plurality of vouchers;
a voucher creation system in communication with the communication source, the voucher creation system allowing at least one entity to create at least a first voucher of the plurality of vouchers for sale through the software platform by identifying terms of the first voucher; and
at least one potential buyer having sufficient access through the software platform to purchase the first voucher.

2. The system of claim 1, further comprising a buying channel between the potential buyer and the entity through a referral source, whereby the potential buyer has sufficient access through the software platform to purchase the first voucher through the referral source.

3. The system of claim 1, further comprising the software platform having the capacity to allow the entity to identify at least one of the group of voucher characteristics consisting of: voucher restrictions; voucher retail value; voucher sale price; voucher restrictions; and a referral fee; in association with the first voucher.

4. The system of claim 1, wherein the plurality of vouchers are created by a plurality of entities.

5. The system of claim 4, further comprising a referral source through whom the first voucher is purchased, wherein the sale of the first voucher includes a referral fee paid to the referral source, wherein the software platform has the capacity to process automatically the payment to the referral source.

6. The system of claim 5, further comprising a channel of communication between the communication source and the referral source, wherein the referral source identifies at least one voucher characteristic desired and the communication source sends vouchers to the referral source having the at least one voucher characteristic.

7. The system of claim 6, wherein the voucher characteristic is a geographic range of redeemability of the vouchers.

8. The system of claim 1, wherein the voucher further comprises a gift certificate and further comprising a transmission mechanism that enables the potential buyer to send a gift certificate to a beneficiary.

9. A method of providing promotional opportunities, comprising the steps of:
forming a communication source within a computer-accessible network having a software platform that supports a sale of a plurality of vouchers;
allowing at least one entity to create at least a first voucher of the plurality of vouchers for sale through the software platform by identifying terms of the first voucher; and
providing access for a potential buyer for purchasing at least one of the plurality of vouchers.

10. The method of claim 9, further comprising the step of providing access for a referral source promoting at least one of the plurality of vouchers.

11. The method of claim 10, further comprising the step of establishing a buying channel through the software platform that allows the potential buyer to purchase the at least one of the plurality of vouchers through the referral source.

12. The method of claim 11, further comprising:
tracking performance, wherein a purchase includes a payment to the referral source; and
automatically processing the payment to the referral source upon sale of one of the plurality of vouchers.

13. The system of claim 11, wherein the referral source identifies at least one voucher characteristic desired and the communication source sends vouchers to the referral source having the at least one voucher characteristic.

14. The system of claim 13, wherein the voucher characteristic is a geographic range of redeemability of the vouchers.

15. The method of claim 9, further comprising allowing the entity to identify at least one of the group of voucher characteristics consisting of: voucher restrictions; voucher retail value; voucher sale price; voucher restrictions; and a referral fee; in association with the first voucher.

16. The method of claim 9, further comprising transmitting the voucher to a beneficiary, wherein the voucher further comprises a gift certificate.

17. A system for providing promotional opportunities, the system comprising:
means for forming a communication source within a computer-accessible network having a software platform that supports a sale of a plurality of vouchers;
means for allowing at least one entity to create at least a first voucher of the plurality of vouchers for sale through the software platform by identifying terms of the first voucher; and
means for providing access for a potential buyer for purchasing at least one of the plurality of vouchers.

18. The system of claim 17, further comprising means for a referral source to communicate to the potential buyer an availability of the first voucher, thereby providing a pathway for the referral source to solicit the potential buyer.

19. The system of claim 17, further comprising:
means for the referral source to sell at least one of the plurality of vouchers to the potential buyer;
means for tracking voucher sales, wherein the accepted offer includes a payment to the referral source upon sale of one of the plurality of vouchers; and
means for automatically processing the payment to the referral source upon sale of one of the plurality of vouchers.

20. An article of manufacture comprising a computer readable-medium having computer readable program code disposed therein to support promotional opportunities within a community, wherein the computer readable program code comprises a series of computer readable program steps to effect:
forming a communication source within a computer-accessible network having a software platform that supports a sale of a plurality of vouchers;
allowing at least one entity to create at least a first voucher of the plurality of vouchers for sale through the software platform by identifying terms of the first voucher; and
providing access for a potential buyer for purchasing at least one of the plurality of vouchers.

21. The article of manufacture of claim 20, wherein said computer readable program code further comprises a computer readable program step of providing access for a referral source promoting at least one of the plurality of vouchers.

22. The article of manufacture of claim 20, wherein said computer readable program code further comprises a computer readable program step of establishing a buying channel through the software platform that allows the potential buyer to purchase the at least one of the plurality of vouchers through the referral source.

23. The article of manufacture of claim 20, wherein said computer readable program code further comprises a computer readable program steps of tracking performance, wherein a purchase includes a payment to the referral source, and automatically processing the payment to the referral source upon sale of one of the plurality of vouchers.

24. The article of manufacture of claim 20, wherein said computer readable program code further comprises computer readable program step of:
allowing the entity to identify at least one of the group of voucher characteristics consisting of: voucher restrictions; voucher retail value; voucher sale price; voucher restrictions, and a referral fee; in association with the first voucher.

25. The method of claim 9, wherein the plurality of vouchers are listed for sale in order of profitability of the vouchers.

26. The method of claim 9, further comprising establishing a promotional channel of communication through the software platform of the community, thereby providing a pathway for a business to solicit a potential buyer.

27. The method of claim 26, wherein a newly available voucher offer is blasted to each potential buyer.

28. The method of claim 27, wherein the newly available voucher offer is added to the bottom of an offer list of each potential buyer.

29. The method of claim 27, wherein the business offer is added to a top of a Top Picks list of one of the potential buyers, wherein the potential buyer previously communicated an interest in a characteristic of the voucher.

30. The method of claim 12, wherein the referral source provides a ranking of the at least one entity in at least one of a plurality of categories.

31. The method of claim 30, wherein the ranking of the at least one entity is determined by feedback from potential buyers.

32. The method of claim 30, wherein the ranking of the at least one entity is determined by tracking performance.

33. The method of claim 30, wherein the at least one entity receives a reward for a substantial ranking in the at least one of a plurality of categories.

34. The method of claim 30, wherein reward is a non-monetary reward.
